(19) United States
(12) Patent Application Publication
(10) Pub. No.: US 2006/0136608 A1
(43) Pub. Date: Jun. 22, 2006

(54) System and method for control registers accessed via private operations

(76) Inventors: Jeffrey D. Gilbert, Portland, OR (US); Harris D. Joyce, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/022,595

(22) Filed: Dec. 22, 2004

(51) Int. Cl. G06F 3/00

(52) U.S. Cl. 710/3

(57) ABSTRACT

A system and method for accessing control registers in a computer system is described. In one embodiment, a control register is given an address which is outside the normal input/output addressable range. Additionally, this control register may be physically located in system circuits separate from the processor functional circuitry. Such a control register may not be accessible via normal user input/output instructions. Special microcode may be used to access these control registers. The special microcode may be executed by special system events. These special events may include loading a microcode patch, or by entering a special debug mode, or by test access using a test access port.

The present invention relates generally to microprocessor systems, and more specifically to microprocessor systems that may use control registers to set system parameters and present system status information.

### BACKGROUND

Microprocessor systems may use various forms of control registers to support their operation. One form of control register may be written to in order to set system parameters and otherwise configure the system. Various combinations of bits in such a register may set operational limits, such as depth of speculative execution or the size of a cache, or may turn on or off optional functional circuitry, such as branch predictors and prefetch units, or may enable or disable interrupts for certain events. Other forms of control registers may be read from in order to receive system status. Such control registers may also be called status registers. The status registers may provide information about system health, contents of program registers associated with a fault condition, operational temperature, and other forms of status. Many control registers may be both written to and read from. Examples of control registers may be the Model Specific Registers (MSRs) implemented in Pentium® class compatible microprocessors.

Control registers generally may be accessed through specific instructions for control register access, or through specific forms of general-purpose user instructions such as input/output (I/O) user instructions. The specific control register access instructions, which may be used for control registers located within a processor, may be limited to executing under high levels of software privilege.

Additionally, various control registers may be required in portions of the system circuitry that are architecturally separate from the processor functional units. For example, such portions may include various chipset functions or may include various intra-system bus bridges. Often these portions of the system circuitry may not be accessible via dedicated circuitry but only by predetermined data paths, including system busses. Conventional control registers located outside of a processor, such as control registers located within a chipset, may need to be accessed via general-purpose I/O user instructions that may be executed under lower levels of software privilege.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 is a diagram of accessing control registers, according to one embodiment of the present disclosure.

FIG. 2 is a diagram of memory address spaces, according to one embodiment of the present disclosure.

FIG. 3 is a diagram of accessing control registers, according to another embodiment of the present disclosure.

FIG. 4 is a diagram of accessing control registers, according to another embodiment of the present disclosure.

FIG. 5A is a schematic diagram of a system with processors capable of accessing control registers, according to an embodiment of the present disclosure.

FIG. 5B is a schematic diagram of a system with processors capable of accessing control registers, according to another embodiment of the present disclosure.

### DETAILED DESCRIPTION

The following description includes techniques for control registers that may have enhanced access protection and that may be located in system components architecturally separate from processor functional blocks. In the following description, numerous specific details such as logic implementations, software module allocation, bus and other interface signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. In certain embodiments, the invention is disclosed in the environment of a Pentium® compatible processor system (such as those produced by Intel® Corporation) and the associated system and processor firmware. However, the invention may be practiced with other kinds of processor systems, such as with an Itanium® Processor Family compatible processor (such as those produced by Intel® Corporation), an X-Scale® family compatible processor, or any of a wide variety of different general-purpose processors from any of the processor architectures of other vendors or designers. Additionally, some embodiments may include or may be special purpose processors, such as graphics, network, image, communications, or any other known or otherwise available type of processor in connection with its firmware.

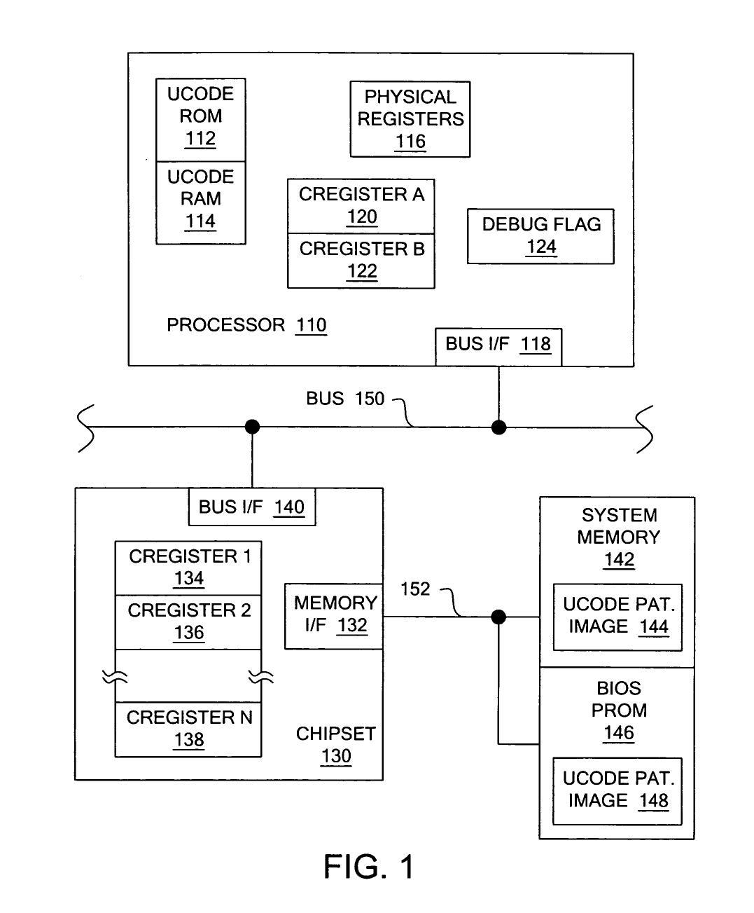

Referring now to FIG. 1, a diagram of accessing control registers is shown, according to one embodiment of the present disclosure. The FIG. 1 system includes a processor 110 and a chipset 130 connected by a bus 150. In other embodiments, additional processors and chipsets may be connected on bus 150. In addition, chipset functions, such as circuits for accessing memory and input/output (I/O) devices, may be distributed among other modules. Processor 110 and chipset 130 may be implemented as separate semiconductor modules, or may be integrated together as a single module. In one embodiment, processor 110 may be a Pentium® class compatible processor, and bus 150 may be a Pentium® compatible front side bus (FSB).

Processor 110 may execute user instructions from an instruction set under the control of microcode. A microcode read-only-memory (ROM) 112 may be provided to store a base microcode set. In addition, a writeable microcode random-access-memory (RAM) 114 may be present to receive another microcode set. In one embodiment, this other microcode set may be loaded from a microcode patch image 144 in system memory 142 or from a microcode patch image 148 in a basic-input/output-system (BIOS) programmable-read-only-memory (PROM) 146. In other embodiments, other forms of system firmware may be used other than BIOS, such as extensible firmware interface (EFI), and other forms of storage other than PROM may be used, such as flash memory.

The FIG. 1 system may use several control registers. These control registers may be read from by processor 110 to yield system status information, or they may be written to by processor 110 to set certain system operational parameters. In some situations control registers that may be read from may be called “status registers”, but for the purpose of the present disclosure the term “control registers” will generally refer to either readable or writeable control registers, or to readable and writable control registers. Conventional control registers may in one embodiment be read from or written to by the execution of user instructions RDMSR (read machine specific register) and WRMSR (write machine specific register). These user instructions may be limited to accessing control registers located in a separate address space that cannot be accessed by other instructions. In one embodiment, conventional user I/O instructions may be used to access conventional control registers located in I/O address space. In one embodiment, such an I/O address space may be limited to 16-bit addresses.

In one embodiment, there may be new embodiment control registers of the present disclosure. Such new control registers may be control registers 1-N (136-138) located within the chipset 130 and control registers A and B (120, 122) located within the processor 110. In each case, the new control registers may have an address outside of the I/O address space. In one embodiment, control registers 1-N (136-138) and control registers A and B (120, 122) have addresses between the top of the Pentium® class compatible processor's I/O address space and the top of the physical address space. In varying embodiments the top of the physical address space may be at (232-1) or (264-1). In other embodiments, other boundaries may exist that delineate I/O address space from the total physical memory space.

Since the address of the control registers 1-N (136-138) are outside of the user I/O address space of processor 110, they may not be accessed via conventional user I/O instructions. Instead, in one embodiment a non-user accessible microcode set may include microcode that permits writing to and reading from control registers 1-N (136-138). In other embodiments, other forms of private operations other than microcode execution may be used to access control registers 1-N (136-138).

In one embodiment, the microcode that permits writing to and reading from control registers 1-N (136-138) and control registers A and B (120, 122) may be modified from existing microcode that implements the user instructions RDMSR and WRMSR. The existing microcode for implementing RDMSR and WRMSR includes a micro-operation that takes the data contained in a 32-bit physical register, representing logical general-purpose register ECX. This 32 bit address is then issued as the address of the desired MSR in the separate address space that contains control registers.

In order to produce microcode that may access the new control registers, such as control registers 1-N (136-138) and control registers A and B (120, 122), the existing microcode for user instructions RDMSR and WRMSR may be modified to convert certain MSR addresses into I/O addresses. In one embodiment the converted address is outside of the user-addressable address range limit that is inherent in conventional user I/O instructions. This resulting modified microcode may then be placed into an alternate microcode set. In other embodiments, microcode other than that of a modified RDMSR or modified WRMSR microcode may be developed to support accessing the new control registers.

It is noteworthy that this technique for accessing control registers 1-N (134-138) may operate across bus 150 via the two bus interface modules 118, 140. In one embodiment bus 150 may support addresses outside the I/O addressable memory space, if for no other reason than that it may support memory accesses across bus 150 and memory interface 132, 152. As the chipset functional circuits of chipset 130 are here shown as being capable of being implemented on a module architecturally separate from processor 110, and being capable of connecting via a bus 150 without additional dedicated signal lines, this technique for accessing control registers may be performed across existing conventional busses such as the FSB.

Because the resulting modified microcode for accessing control registers 1-N (136-138) and control registers A and B (120, 122) is not normally available to the user, specific triggering conditions for its execution may be imposed. For example, in one embodiment the loading of microcode patch image 144 or microcode patch image 148 into microcode RAM 114 may trigger the execution of the modified microcode. (The loading of either microcode patch image 144 or microcode patch image 148 may in turn be triggered by the removing of the RESET# signal from processor 110.) In this manner, control bits from the microcode patch may be written into control registers 1-N (136-138) and control registers A and B (120, 122) as part of the loading of the microcode patch.

In another embodiment, there may be two sets of microcode in microcode ROM 112: one set for user instruction microcode and another for use in debug mode. In other embodiments, the two sets of microcode may be split between microcode ROM 112 and microcode RAM 114. A debug flag 124 may be used to indicate whether processor 110 is in user mode or in debug mode. Debug flag 124 may in some embodiments be set (logic true) during manufacture and may be cleared (logic false) during some part of final manufacturing test or preparation for delivery. In some embodiments, there may be a special electronic procedure to set and later clear debug flag 124 after delivery of the processor 110.

When the debug flag 124 is set, the second set of microcode may be enabled for execution by a privileged user. In this manner the microcode for accessing selected new control registers, such as control registers 1-N (136-138) and control registers A and B (120, 122), may be restricted to executing only in debug mode. When the debug flag is cleared prior to delivery of processor 110, this clearing may prevent end users from accessing the control registers.

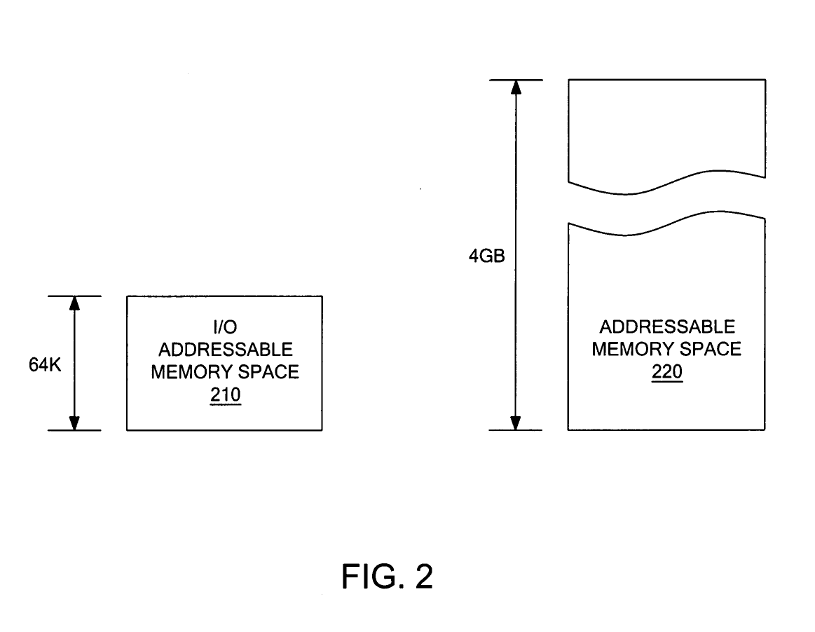

Referring now to FIG. 2, a diagram of memory address spaces is shown, according to one embodiment of the present disclosure. An I/O addressable memory space 210 is shown separately addressed when compared with the addressable memory space 220. In one embodiment, this I/O addressable memory space 210 may be that which can be addressed with 16 bits of address (i.e. (2¹⁶⁻¹)or 64K bytes). In other embodiments, a few more addresses may be added, giving an I/O addressable memory space 210 of 64 Kbytes+N bytes, where in one embodiment N=3. In embodiments where a processor uses 32 bit memory addresses, the addressable memory space 220 may be 2³² or 4 G bytes: in other embodiments where a processor uses 64 bit memory addresses, the addressable memory space 220 may be 264 bytes.

In FIG. 2, the portion of the memory space which is only accessible through memory operations and other microcode operations, the addressable memory space 220, is shown as being orthogonal to the I/O addressable memory space 210. In other embodiments, there may be differing sets of boundaries between I/O addressable memory space 210 and addressable memory space 220.

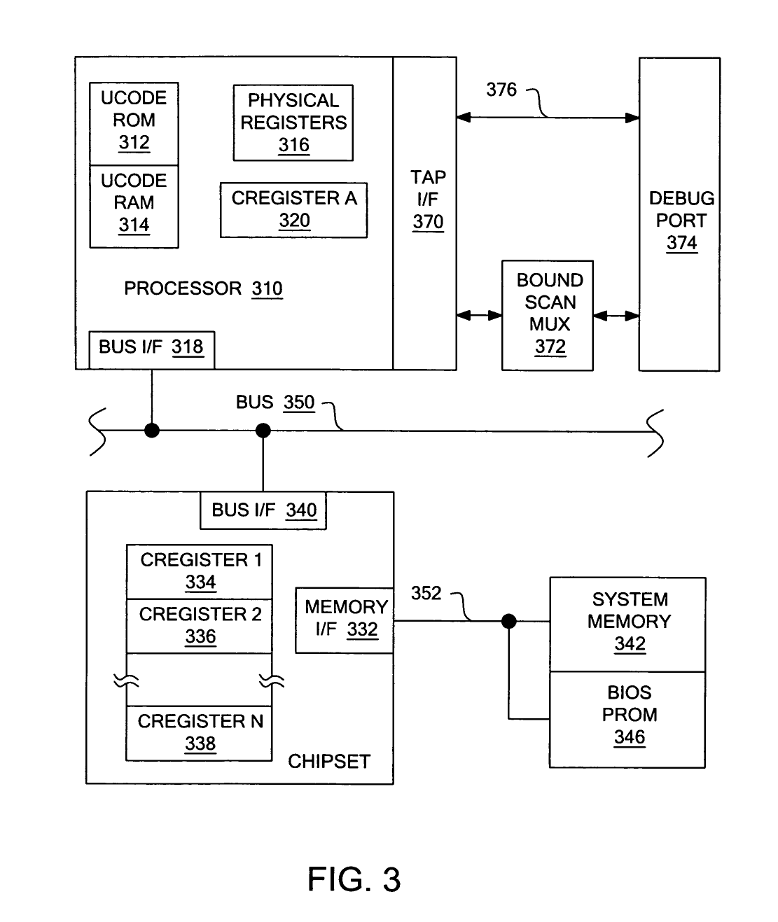

Referring now to FIG. 3, a diagram of accessing control registers is shown, according to another embodiment of the present disclosure. Processor 310 may be configured to operate with an Institute of Electrical and Electronics Engineers (IEEE) Std. 1149 specification compliant test access port (TAP) (“IEEE Standard Test Access Port and Boundary-Scan Architecture”, IEEE Std. 1149.1-1990). Here processor 130 is shown having a TAP interface 370, which permits it to be accessed by an IEEE Std. 1149 compatible debug port 374. The debug port 374 may control the processor 310 directly via interface 376 and by the signal buffering offered by boundary scan multiplexer 372.

The debug port 374 may permit a user to access portions of the logic of processor 310 not normally accessible by that user. In one embodiment, the debug port 373 may permit the user to execute non-user-instruction microcode. This may permit the user to execute the microcode that may access control registers, such as control registers 1-N (334-338) and control register A 320, that have addresses outside the I/O addressable memory space. Here, as in the FIG. 1 embodiment, the user instructions may be implemented by one set of microcode, and the microcode that may access these control registers may belong to another set of microcode.

In other embodiments, the debug port 374 may be used to write directly to the control registers, such as control registers 1-N (334-338) and control register A 320.

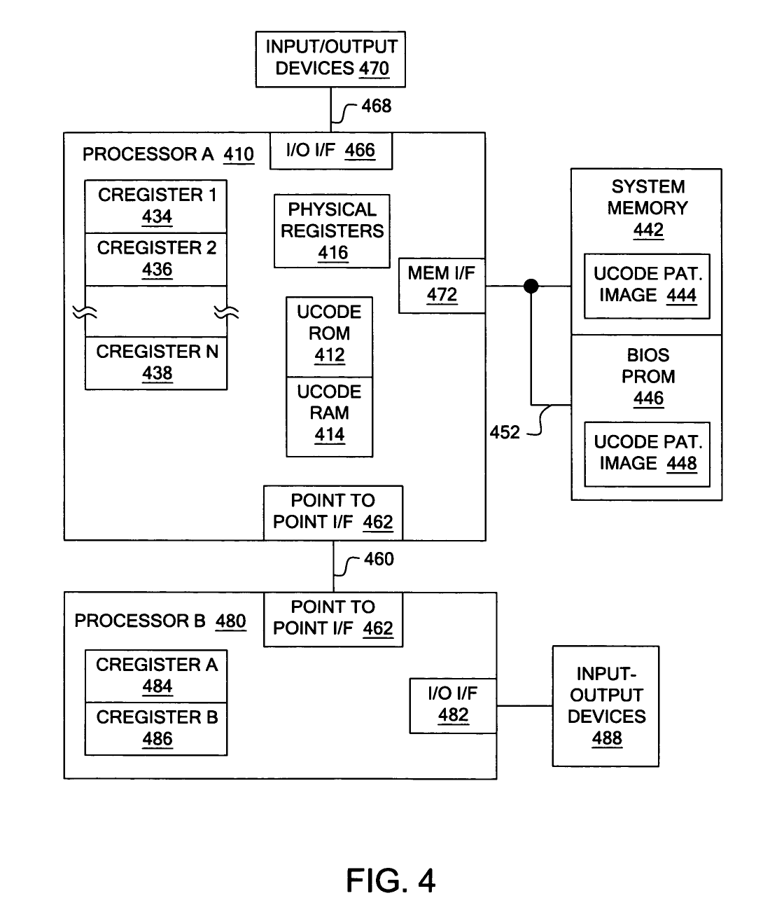

Referring now to FIG. 4, a diagram of accessing control registers is shown, according to another embodiment of the present disclosure. In the FIG. 4 embodiment, processors 410 and 480 do not exchange data via a multi-drop bus, but rather via a point-to-point data link 460. Additionally, a separate chipset is not used. Instead, selected chipset functions such as memory interface 472 and I/O interface 466 are integrated with processor 410.

Processor 410 may include control registers of the present disclosure, such as control registers 1-N (434-438). Processor 480 may also include control registers capable of being accessed from processor 410, control registers A and B (484, 486). It is noteworthy that this technique for accessing control registers A and B (484, 486) may operate across point-to-point data link 460 via the two point-to-point interface modules 462, 464. In one embodiment point-to-point data link 460 may support addresses outside the I/O addressable memory space, if for no other reason than that it may support memory accesses from processor B 480 across point-to-point data link 460 and memory interface 472, 452. Each of control registers 1-N (434-438) and control registers A and B (484, 486) have addresses outside of the I/O addressable memory space.

A microcode ROM 412 may be provided to store a base microcode set, and a microcode RAM 414 may be present to receive another microcode set. In one embodiment, this other microcode set may be loaded from a microcode patch image 444 or from a microcode patch image 448. In one embodiment a non-user accessible microcode set may include microcode that permits writing to and reading from control registers 1-N (434-438) and control registers A and B (484, 486).

Because the microcode for accessing control registers 1-N (434-438) and control registers A and B (484, 486) is not normally available to the user, specific triggering conditions for its execution may again be imposed. For example, in one embodiment the loading of microcode patch image 444 or microcode patch image 448 into microcode RAM 414 may trigger the execution of the modified microcode. In this manner, control bits from the microcode patch may be written into control registers control registers 1-N (434-438) and control registers A and B (484, 486) as part of the loading of the microcode patch. Alternatively, the second set of microcode may be present in microcode ROM 412, and the microcode for accessing control registers 1-N (434-438) and control registers A and B (484, 486) may be executed during a debug mode as discussed above in connection with FIG. 1, or by action of a test access port as discussed above in connection with FIG. 3.

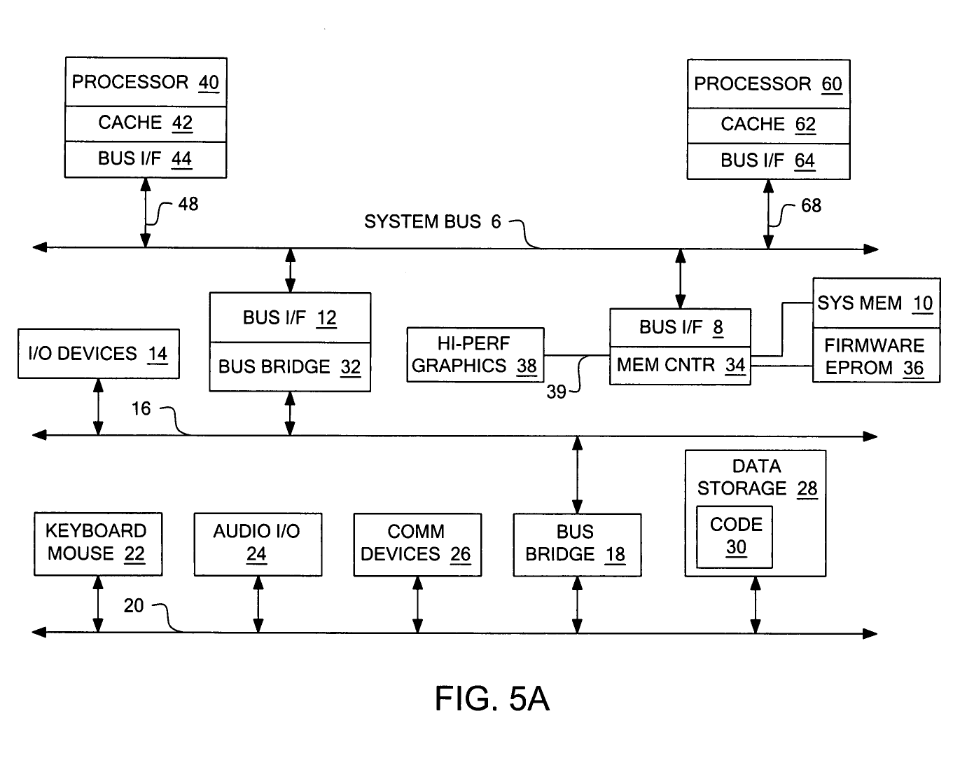

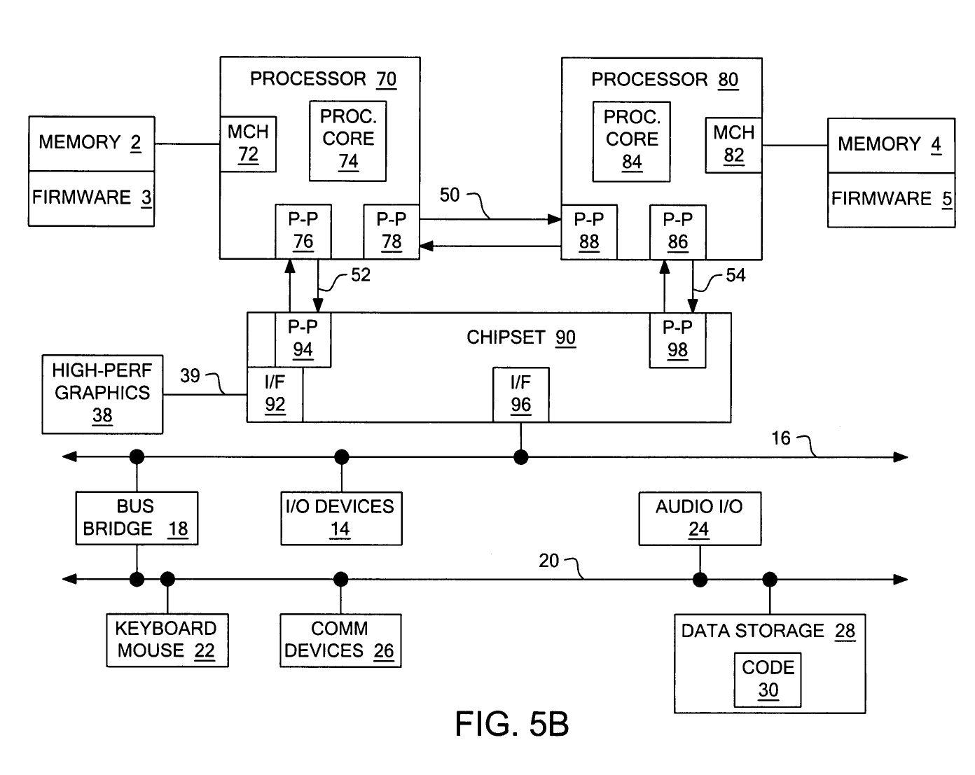

Referring now to FIGS. 5A and 5B, schematic diagrams of systems with processors capable of accessing control registers of the present disclosure are shown, according to two embodiments of the present disclosure. The FIG. 5A system generally shows a system where processors, memory, and input/output devices are interconnected by a system bus, whereas the FIG. 5B system generally shows a system where processors, memory, and input/output devices are interconnected by a number of point-to-point interfaces.

The FIG. 5A system may include one or several processors, of which only two, processors 40, 60 are here shown for clarity. Processors 40, 60 may include level one caches 42, 62. The FIG. 5A system may have several functions connected via bus interfaces 44, 64, 12, 8 with a system bus 6. In one embodiment, system bus 6 may be the front side bus (FSB) utilized with Pentium® class microprocessors manufactured by Intel® Corporation. In other embodiments, other busses may be used. In some embodiments memory controller 34 and bus bridge 32 may collectively be referred to as a chipset. In some embodiments, functions of a chipset may be divided among physical chips differently than as shown in the FIG. 5A embodiment.

Memory controller 34 may permit processors 40, 60 to read and write from system memory 10 and from a firmware erasable programmable read-only memory (EPROM) 36. In some embodiments the firmware may present a microcode patch image for loading into a microcode RAM (not shown) of processors 40, 60. In some embodiments firmware EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface. Memory controller 34 may direct data from system memory 10 to the high-performance graphics circuit 38 across high-performance graphics interface 39.

The FIG. 5B system may also include one or several processors, of which only two, processors 70, 80 are shown for clarity. Processors 70, 80 may each include a local memory controller hub (MCH) 72, 82 to connect with memory 2, 4 and with firmware 3, 5. In some embodiments the firmware may present a microcode patch image for loading into a microcode RAM (not shown) of processors 70, 80. Processors 70, 80 may exchange data via a point-to-point interface 50 using point-to-point interface circuits 78, 88. Processors 70, 80 may each exchange data with a chipset 90 via individual point-to-point interfaces 52, 54 using point to point interface circuits 76, 94, 86, 98. Chipset 90 may also exchange data with a high-performance graphics circuit 38 via a high-performance graphics interface 92.

In the FIG. 5A system, bus bridge 32 may permit data exchanges between system bus 6 and bus 16, which may in some embodiments be a industry standard architecture (ISA) bus or a peripheral component interconnect (PCI) bus. In the FIG. 5B system, chipset 90 may exchange data with a bus 16 via a bus interface 96. In either system, there may be various input/output I/O devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28, and in some embodiments software code 30 may include a microcode patch image. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus, comprising:
logic to perform selected chipset functions;
a bus interface to couple with a processor; and
a control register accessed by an address outside of an input/output address space of said processor.

2. The apparatus of claim 1, wherein said address is supported by said bus interface.

3. The apparatus of claim 1, wherein said address is supported by a physical register of said processor.

4. A processor, comprising:
a first logic to execute an instruction set under control of a first microcode set;
a physical register to contain an address not included in an input/output address space of said instruction set; and
a second logic to access a control register using said address.

5. The processor of claim 4, further comprising a third logic to receive a second microcode set.

6. The processor of claim 5, wherein said second microcode set includes microcode to issue said address from said physical register.

7. The processor of claim 5, wherein said third logic to receive said second microcode set from external memory.

8. The processor of claim 5, further comprising a bus interface to transmit said address external to said processor.

9. The processor of claim 4, further comprising a second microcode set including microcode to issue said address to a control register.

10. The processor of claim 9, further comprising a debug flag to indicate that said second microcode set may be executed.

11. The processor of claim 10, wherein said debug flag is to be cleared during an acceptance test of said processor.

12. The processor of claim 10, wherein said debug flag is to be set by a post-acceptance test procedure.

13. The processor of claim 9, further comprising a test access port interface to receive a test command.

14. The processor of claim 13, wherein said second microcode set may be executed in response to said test command.

15. The processor of claim 9, further comprising a bus interface to transmit said address external to said processor.

16. A system, comprising:
a processor including a first logic to execute an instruction set under control of a first microcode set, and a physical register to contain an address not included in an input/output address space of said instruction set; and
a module including a second logic to perform selected chipset functions, an interface to couple said module with said processor, and a control register accessed by said address.

17. The system of claim 16, wherein said processor includes a third logic to receive a second microcode set.

18. The system of claim 17, wherein said second microcode set includes microcode to issue said address from said physical register to access said control register.

19. The system of claim 17, wherein said second logic and said third logic to load said second microcode set into said third logic.

20. The system of claim 19, wherein said second microcode set is loaded from a second microcode set image stored external to said system.

21. The system of claim 16, wherein said interface is a bus between said processor and said module.

22. The system of claim 16, wherein said processor further includes a second microcode set including microcode to access said control register using said address.

23. The system of claim 22, wherein said processor further includes a debug flag to indicate that said second microcode set may be executed.

24. The system of claim 23, wherein said debug flag is to be cleared during an acceptance test of said processor.

25. The system of claim 23, wherein said debug flag is to be set by a post-acceptance test procedure.

26. The system of claim 22, wherein processor includes a test access port interface to receive a test command.

27. The system of claim 26, wherein said second microcode set may be executed in response to said test command.

28. A method, comprising:
placing an address of a control register into a physical register of a processor, where said address is not included in an input/output address space of an instruction set under control of a first microcode set; and
issuing said address from said physical register to said control register under control of a second microcode set.

29. The method of claim 28, further comprising loading said second microcode set into said processor.

30. The method of claim 29, further comprising executing said second microcode set responsive to said loading.

31. The method of claim 28, further comprising checking status of a debug flag to determine whether a processor is in debug mode.

32. The method of claim 31, wherein said issuing is responsive to said checking.

33. The method of claim 31, further comprising clearing said debug flag responsive to an acceptance test.

34. The method of claim 31, further comprising setting said debug flag responsive to a post-acceptance test.

35. The method of claim 29, wherein said issuing is responsive to a test command received from a test access port interface.

36. An apparatus, comprising:
means for placing an address of a control register into a physical register of a processor, where said address is not included in an input/output address space of an instruction set under control of a first microcode set; and
means for issuing said address from said physical register to said control register under control of a second microcode set.

37. The apparatus of claim 36, further comprising means for loading said second microcode set into said processor.

38. The apparatus of claim 37, further comprising means for executing said second microcode set responsive to said means for loading.

39. The apparatus of claim 36, further comprising means for checking status of a debug flag to determine whether a processor is in debug mode.

40. The apparatus of claim 39, wherein said means for issuing is responsive to said means for checking.

41. The apparatus of claim 39, further comprising means for clearing said debug flag responsive to an acceptance test.

42. The apparatus of claim 41, further comprising means for setting said debug flag responsive to a post-acceptance test.

43. The apparatus of claim 36, wherein said means for issuing is responsive to a test command received from a test access port interface.

44. A computer-readable media containing software code that, when executed by a processor, performs the process comprising:
placing an address of a control register into a physical register of a processor, where said address is not included in an input/output address space of an instruction set under control of a first microcode set; and
issuing said address from said physical register to said control register under control of a second microcode set.

45. The computer-readable media of claim 44, further comprising an image of said second microcode set for loading into said processor.

46. The computer-readable media of claim 45, further comprising executing said second microcode set responsive to loading said image of said second microcode set into said processor.

47. The computer-readable media of claim 44, further comprising checking status of a debug flag to determine whether a processor is in debug mode.

48. The computer-readable media of claim 47, wherein said issuing is responsive to said checking.

49. The computer-readable media of claim 48, further comprising clearing said debug flag responsive to an acceptance test.

50. The computer-readable media of claim 48, further comprising setting said debug flag responsive to a post-acceptance test.

51. The computer-readable media of claim 44, wherein said issuing is responsive to a test command received from a test access port interface.
